(19) United States
(12) Patent Application Publication
(10) Pub. No.: US 2026/0148343 A1
(43) Pub. Date: May 28, 2026

(54) SYSTEM FOR CREATING HIGH-RESOLUTION IMAGES AND RELATED DEVICES AND METHODS

(71) Applicant: Upfeat Media Inc., Winnipeg (CA)

(72) Inventor: Matthew Tate, Winnipeg (CA)

(21) Appl. No.: 19/398,990

(22) Filed: Nov. 24, 2025

Related U.S. Application Data
(60) Provisional application No. 63/723,890, filed on Nov. 22, 2024.

(51) Int. Cl. G06T 5/50; G06T 3/40; G06T 5/60; G06T 5/80

(52) U.S. Cl. CPC G06T 5/50; G06T 3/40; G06T 5/60; G06T 5/80; G06T 2207/10148; G06T 2207/20221

(57) ABSTRACT

The various implementations disclosed herein are directed to a system for generating composite images with effective resolution greater than a single native capture of the same scene, and related devices and methods. Through the use of an optical subsystem configured to vary magnification and/or a region of interest within a field of view, the implementations described in this disclosure can automatically generate composite images.

### CROSS-REFERENCES & RELATED APPLICATIONS

This application claims priority to U.S. Provisional Application No. 63/723,890 filed Nov. 22, 2024, and entitled “SYSTEM FOR CREATING HIGH-RESOLUTION IMAGES AND RELATED DEVICES AND METHODS,” which is hereby incorporated by reference in its entirety under 35 U.S.C. § 119(e).

### TECHNICAL FIELD

The disclosure relates to image processing, generally, and composite image formation, specifically.

### BACKGROUND

Contemporary image splicing and compositing devices and techniques often require technical knowledge and precision when capturing images to be composited. Such contemporary image compositing techniques require the used imaging device to be repositioned to capture several images to be stitched together. There is a need in the art for a system that allows for automatic generation of images of higher resolution than the nominal resolution of the equipment used without the need to reposition the equipment.

### BRIEF SUMMARY OF THE INVENTION

The various implementations described herein are directed to a system for generating images with higher resolution than would be otherwise be possible based on the used hardware. In some implementations, this is accomplished using, in part, a lens with an adjustable focal length and adjustable focal point position, such as a periscope lens. As would be understood, the ability to adjust the focal point position of the system allows the system to take different images, which may then be formed into a composite image, without the need to reposition equipment.

A system of one or more computers or computing devices and control circuitry can be configured to perform particular operations or actions by virtue of having software, firmware, hardware, or a combination of them installed on the system that in operation causes or cause the system to perform the actions. One or more computer programs or models can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive

Example 1 relates to a system for producing high resolution images comprising a device comprising a camera comprising a lens with an adjustable focal length and adjustable focal point position, wherein the device is configured to automatically create one or more tile images by adjusting the adjustable focal length and adjustable focal point position.

Example 2 relates to Examples 1 and 3-7, wherein the tile images are combined to generate a composite image.

Example 3 relates to Examples 1-2 and 4-7, wherein each of the one or more tile images is created by taking a digital photograph when the adjustable focal point position is centered on one of a plurality of partitions.

Example 4 relates to Examples 1-3 and 5-7, wherein the composite image is generated using an AI program.

Example 5 relates to Examples 1-4 and 6-7, wherein each of the one or more tile images comprise a core image that overlaps with the partition upon which the adjustable focal point position is centered when the tile image was created; and an overlap that extends from the core image.

Example 6 relates to Examples 1-5 and 7, wherein the composite image is generated by aligning the overlap of each of the one or more tile images with the overlaps of other tile images.

Example 7 relates to Examples 1-6, wherein each of the one or more tile images are corrected for optical distortion.

Example 8 relates to a device for producing high resolution images comprising a camera comprising a lens with an adjustable focal length and adjustable focal point position, wherein the device is configured to generate a composite image, created by merging a plurality of tile images obtained by adjusting the adjustable focal point position.

Example 9 relates to Examples 8 and 10-16, wherein the device is internet-enabled and configured to be in electronic communication with one or more cloud servers.

Example 10 relates to Examples 8-9 and 11-16, wherein generation of the composite image is done within the one or more cloud servers.

Example 11 relates to Examples 8-10 and 12-16, wherein the one or more cloud servers are configured to use an artificial intelligence model to generate the composite image.

Example 12 relates to Examples 8-11 and 13-16, wherein the adjustment of the adjustable focal point position is controlled by an artificial intelligence program.

Example 13 relates to Examples 8-12 and 14-16, wherein the artificial intelligence model identifies areas of high feature density and low feature density areas of a scene.

Example 14 relates to Examples 8-13 and 15-16, wherein the artificial intelligence model overlays a plurality of partitions on the scene.

Example 15 relates to Examples 8-14 and 16, wherein more partitions of the plurality of partitions are overlayed in areas of high feature density and fewer partitions of the plurality of partitions are overlayed in low feature density areas.

Example 16 relates to Examples 8-15, wherein the adjustable focal point position is adjusted to be centered on each of the plurality of partitions.

Example 17 relates to a system for producing high resolution images comprising a device comprising a camera comprising a lens with an adjustable focal point position, wherein the device is configured to automatically create one or more tile images by adjusting the adjustable focal point position, and wherein taking a digital photograph when the adjustable focal point position is centered on one of a plurality of partitions.

Example 18 relates to Examples 17 and 19-20, wherein each of the plurality of partitions are of equal size.

Example 19 relates to Examples 17-18 and 20, wherein a size and position of each of the plurality of partitions is determined by the presence and position of one or more areas of high feature density and low feature density areas of a scene.

Example 20 relates to Examples 17-19, wherein more partitions of the plurality of partitions are overlayed in areas of high feature density and fewer partitions of the plurality of partitions are overlayed in low feature density areas.

### BRIEF DESCRIPTION OF DRAWINGS

FIG. 1 is diagram of the system capturing a scene within a frame, according to one implementation.

FIG. 2 is a diagram of the system with partitions established, according to one implementation.

FIG. 3 is a diagram of the system with the focal point position centered on a partition, according to one implementation.

FIG. 4A is a diagram of the system with the focal point position centered on the first partition, according to one implementation.

FIG. 4B is a diagram of the system with the focal point position centered on the second partition, according to one implementation.

FIG. 4C is a diagram of the system with the focal point position centered on the third partition, according to one implementation.

FIG. 4D is a diagram of the system with the focal point position centered on the fourth partition, according to one implementation.

FIG. 5 is a diagram of the tile images being formed into a composite image, according to one implementation.

FIG. 6 is a flowchart of a configured stitching method, according to one implementation.

FIG. 7A is diagram of a scene with areas of emphasis and low feature density areas identified, according to one implementation.

FIG. 7B is a diagram of partitions that were established according to the location of areas of emphasis and low feature density areas, according to one implementation.

FIG. 8 is a flowchart of an AI-powered method, according to one implementation.

### DETAILED DESCRIPTION

The various implementations disclosed herein are directed to a system of capturing images with resolutions higher than the nominal resolution of the devices used, as well as related devices and methods. In various implementations, a composite image of a scene is produced with effective resolution greater than a single native capture of the scene.

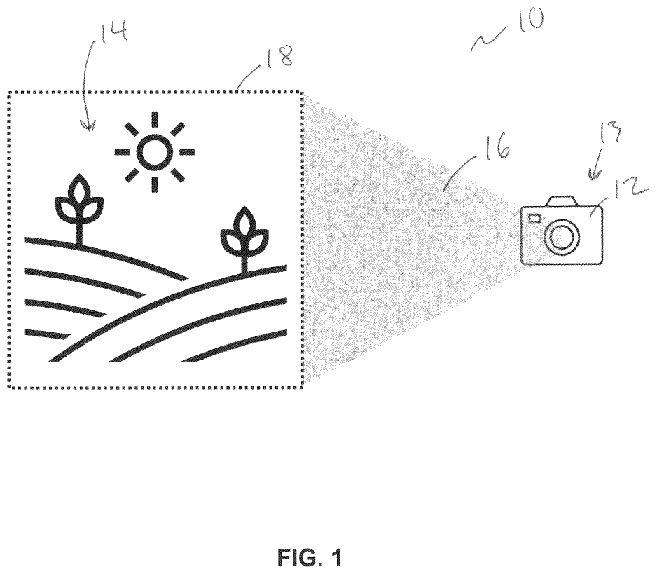

Shown in FIG. 1, various implementations of the imaging system 10 include a camera 12 capable of making digital images of a scene 14. As would be understood, the camera 12 can be a stand-alone device or can be integrated into a device 13, such as a smartphone 13, tablet 13, computer 13, or the like. In various implementations of the system 10, computations performed by the system 10 can be performed by the device 13 or can be performed via cloud computing. As would be understood, the device 13 can be an internet-enabled or Internet of Things device, whereby the device 13 can convey the necessary and receive information to cloud servers.

In certain implementations of the system 10, the camera 12 can have a lens that is configured to adjust its focal length and its focal point position 16. In specific implementations, the camera 12 may have a periscope lens configured to adjust its focal length and its focal point position 16, although other types of lenses are possible.

In some embodiments, the focal point position 16 can be adjusted through configurations where the camera 12 can be repositioned, but the system 10 stays relatively stationary. An example of such an implementation is mounting the camera 12 to an automatically positionable mount (not shown) that can be controlled by the system 10. Another example of such an implementation is mounting the camera 12 to a vehicle, such as an aerial drone, which can be controlled and repositioned by the system 10.

In some embodiments, the focal point position 16 can be adjusted through configurations where the camera 12 can be repositioned, but the system 10 stays relatively still. An example of such an implementation is mounting the camera 12 to an automatically positionable mount (not shown) that can be controlled by the system 10. Another example of such an implementation is mounting the camera 12 to a vehicle, such as an aerial drone, which can be controlled and repositioned by the system 10. In addition to adjustable focal length, the system 10 can be configured to vary magnification and/or the region of interest without physically repositioning the device.

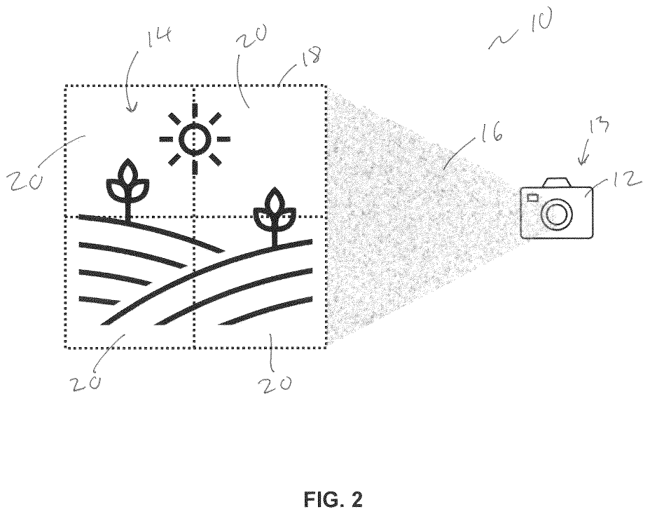

In various implementations, a frame 18 bounds the scene 14 to be imaged by the camera 12, defining what is and is not included in the resulting digital image. As shown in FIG. 2, in various implementations, the frame 18 may be divided into one or more partitions 20 by the system 10, in which each partition makes up a smaller portion of the image of the scene 14 than is encompassed by the frame 18. The division of the frame 18 into partitions 20 can be performed by a control unit (not shown), optionally contained in the camera 12, in the broader device such as a smartphone, or in a separate component in electronic communication with the system 10. In the particular implementation shown in FIG. 2, there are four partitions 20, but any number of partitions 20 can be used. Increasing the number of partitions 20 can increase the resolution of the final image but can increase the computational power required. Likewise, decreasing the number of partitions 20 can reduce the required computational power, but can result in a lesser improvement in resolution of the final image. Additionally, the partitions 20 can be variable in size relative to one another, and their size can be adapted and adjusted as desired, as will be discussed in more detail below.

The disclosed implementation of optical control and capture increases within-frame sampling density by acquiring partially overlapping higher-magnification views and fusing them, thereby achieving an effective resolution beyond a single native capture of the same scene by the device. This constitutes a concrete improvement in imaging device operation.

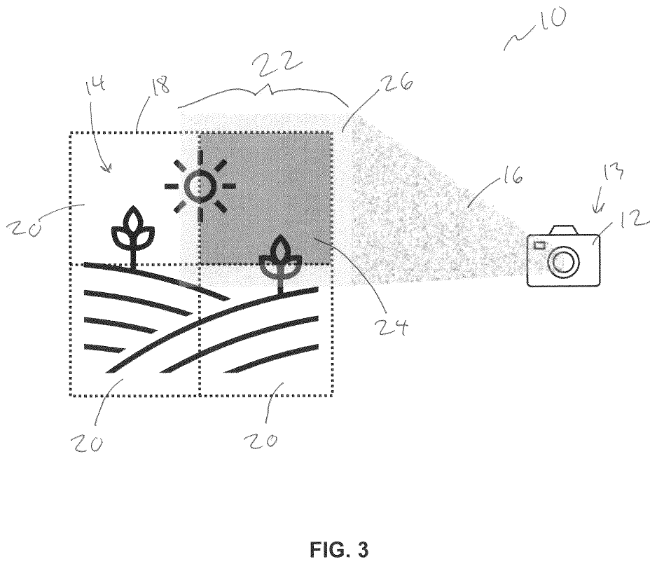

In some implementations of the system 10, such as shown in FIG. 3, the camera 12 can adjust its focal point position 16 to align with a partition 20. In this process, the camera 12 can also increase its focal length, which can have the effect of “zooming in” on a particular partition 20. As would be understood, using an optical lens to increase the focal length of the camera 12 will result in image with a smaller scope and with higher resolution relative to the features being photographed, meaning there will be more digital pixels describing any particular feature within the photograph. In various implementations, the focal point position 16 is adjusted automatically by the system 10, not by a user. The focal point position 16 may be adjusted by actuating the lens, such as a periscope lens, while the camera 12 remains stationary. For the purposes of this disclosure, the adjustment of the focal point position 16 while the camera 12 remains stationary can be referred to as “automatic” or done “automatically”. As would be understood, the automatic adjustment does not require the user to adjust the position of the camera 12 or device 13 to adjust the focal point position 16.

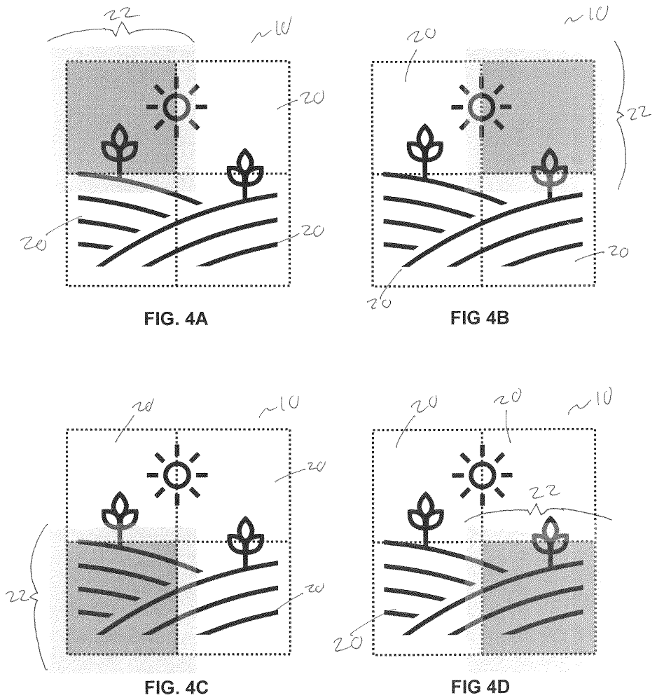

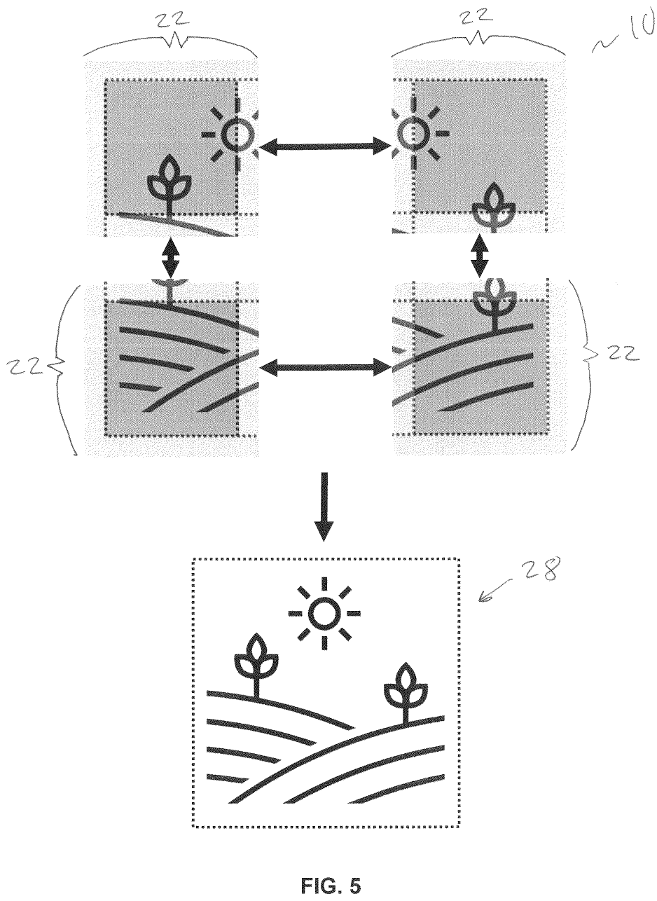

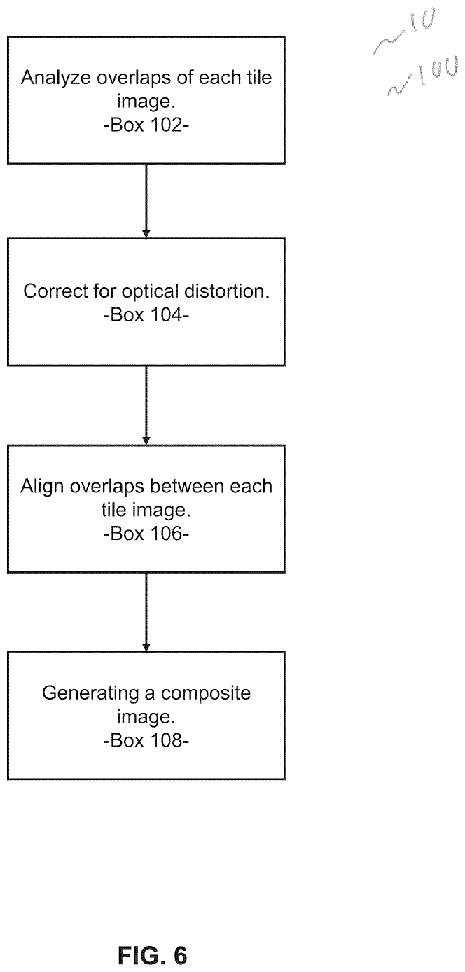

In various implementations, camera 12 can take a tile image 22, which is a digital picture, while the camera's lens is zoomed in on and the focal point position is centered on a particular partition 20. The tile image 22, in some implementations, can have a core image 24, which overlaps with the relevant partition 20, and an overlap 26, which extends out from the core image 24. As shown by FIGS. 4A-4D, in various implementations, the camera 12 can take tile images 22 for every partition 20 in the frame 18. In some implementations, the relative position of each tile image 22 relative to the frame 18 is documented by the system 10, optionally by the control unit.

In various implementations, the system 10 can create a composite image 28 by stitching the individual tile images 22 together. In some implementations, the tile images 22 can be stitched together using a configured stitching method 100.

The specific implementation of the configured stitching method 100 described herein is intended to be merely exemplary of the broader method 100, and it is not intended to be an exclusive or exhaustive recitation of the method 100. Additionally, the described steps need not be performed in the particular order described and may be omitted as may be required for a particular application. In some implementations, the configured stitching method 100 can begin by analyzing the overlaps 26 of each tile image 22 for optical distortion (box 102). As would be understood, the presence of optical distortion can be detected from misalignment of detected features in the overlaps 26. The system 10 can correct for detected optical distortions (box 104), such as by stretching or otherwise manipulating one or more tile images 22 to align the detected features. The system 10 can align the overlaps 26, whereby the tile images 22 are likewise aligned (box 106). The tile images 22 can then be combined into a composite image 28 that can have a higher resolution than the individual tile images 22 (box 108).

Registration can include correction using a parametric lens model (e.g., radial-tangential distortion) followed by feature detection, descriptor matching, outlier rejection, and estimation of geometric transforms such as homographies or poses. Blending techniques (e.g., multi-band blending) can reduce seam visibility.

Various implementations of the system 10 can also use artificial intelligence (“AI”) in executing necessary computations. In some implementations, the system 10 can execute a trained model or heuristic model to determine the sizing, placement, and order of partitions 20 and to generate control signals for the optical subsystem.

In various implementations, the system 10 can execute a trained model on the control unit to directly command variation of magnification/focal length and/or region of interest. In such implementations, the trained model can adjust these parameters through repositioning of a periscope lens, through repositioning of a vehicle on which the camera 12 is mounted, or through other such techniques known to those in the art.

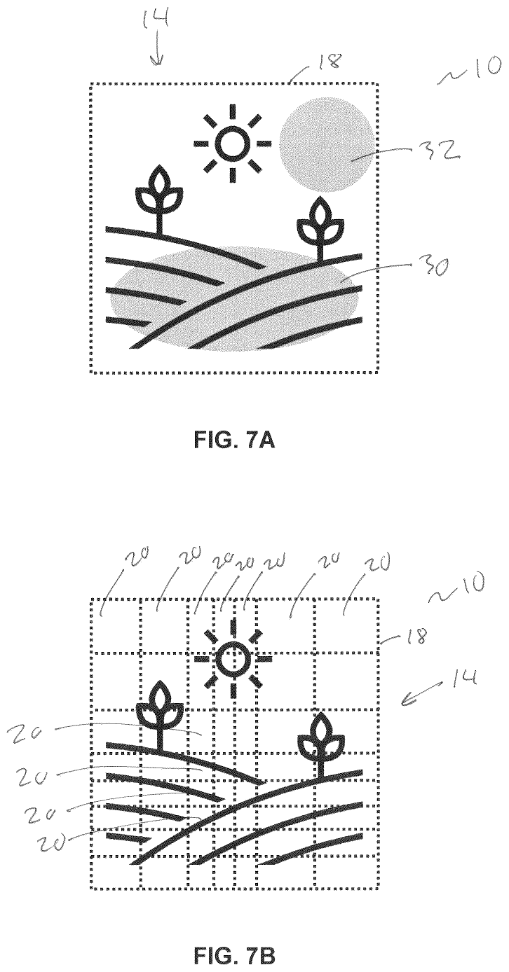

In various implementations, the system 10 can create a composite image 28 by executing an AI model, such as a deterministic model. As shown in FIG. 7A, in such implementations, the system 10 can execute a trained model or deterministic detector to identify regions with high feature density 30 and low feature density 32 within the scene 14. The regions with high feature density 30 may tend to be areas of the scene 14 with many features, details, intricacies, and the like, whereas regions with low feature density 32 may tend to be background areas, areas of homogenous or similar colors, or other areas lacking detail.

Turning to FIG. 7B, once the system 10 has identified areas of high feature density 30 and/or low feature density areas 32, the system 10 can adjust the size of the partitions 20 to concentrate more partitions 20 into areas of emphasis or high feature density 30 while placing fewer partitions 20 in low feature density areas 32. As would be understood, having more, smaller partitions 20 in areas of emphasis or high feature density 30 will result in increased fidelity and resolution in those areas of the composite image 28, and having fewer, larger partitions 20 in low feature density areas 32 will reduce the computational requirements in generating the composite image 28.

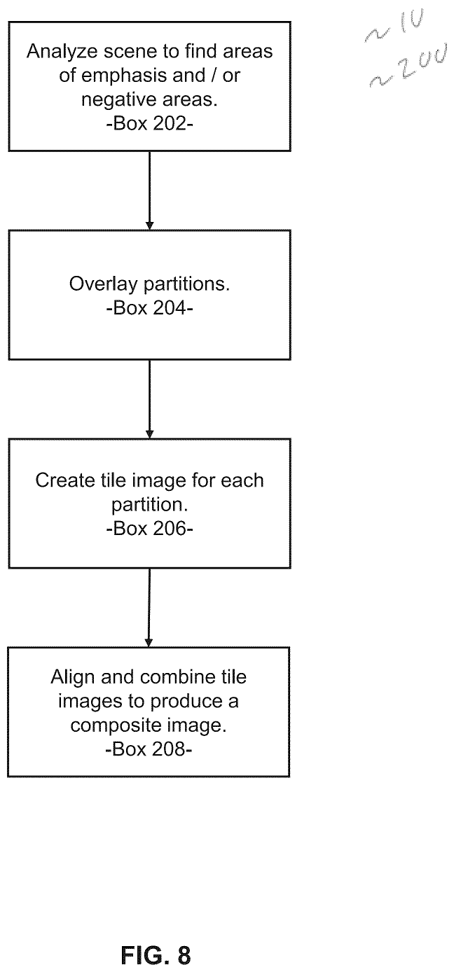

In various implementations, the system 10 can use an AI-powered method 200 to create a high-resolution composite image 28. The specific implementation of the AI-powered method 200 described herein and shown in FIG. 8 is intended to be merely exemplary of the broader method 200, and it is not intended to be an exclusive or exhaustive recitation of the method 200. Additionally, the described steps need not be performed in the particular order described and may be omitted as may be required for a particular application.

In various implementations of the AI-powered method 200, the system 10 can analyze a scene 14, as viewed through the lens of the camera 12, to determine the presence and location of areas of emphasis or high feature density 30 and low feature density areas 32 (box 202), although the system 10 may proceed with the method 200 without performing this step in other implementations. In some implementations, the system 10 can overlay partitions 20 within the frame 18 (box 204). In certain implementations, the partitions 20 may be sized and located according to the presence and location of areas of emphasis or high feature density 30 and low feature density areas 32, as discussed above. In other implementations, the partitions 20 may be sized and located in a predetermined pattern.

In various implementations of the AI-powered method 200, the system 10 can create a tile image 22 for each partition 20 by centering the focal point position 16 on each partition, adjusting the focal length appropriately, and taking a digital picture (box 206). In some implementations, the system 10 can automatically adjust the focal point position 16 and focal length to move between each partition 20. In certain implementations, the automatic adjustment of the focal point position 16 and focal length can be controlled and optimized by an AI program. In various implementations, the system 10 can align and combine the tile images 22 of each partition 20 into a composite image 28 (box 208). In some implementations, the tile images 22 are adjusted for optical distortion, aligned, and combined by an AI program.

One of many benefits of the various implementations disclosed here is the ability to generate an image with a higher resolution than would traditionally be possible with the devices used. Additionally, the various implementations can automatically create the high resolution composite image without the need for a user to capture numerous overlapping images. Because the implementations can automatically zoom and reposition the focal point position, the various implementations can be integrated more seamlessly into devices intended for consumers without technical photographic knowledge.

Although the disclosure has been described with reference to preferred implementations, persons skilled in the art will recognize that changes may be made in form and detail without departing from the spirit and scope of the disclosed apparatus, systems and methods.

What is claimed is:

1. A system for producing high resolution images, the system comprising:
a device comprising:
a camera comprising:
a lens with an adjustable focal length and adjustable focal point position,
wherein the device is configured to automatically create one or more tile images by adjusting the adjustable focal length and adjustable focal point position, and
wherein the device is configured to execute an artificial intelligence model to generate a composite image from the one or more tile images with an effective resolution greater than a single native capture.

2. The system of claim 1, wherein each of the one or more tile images is created by taking a digital photograph when the adjustable focal point position is centered on one of a plurality of partitions.

3. The system of claim 2, wherein each of the one or more tile images comprise:
(a) a core image that overlaps with the partition upon which the adjustable focal point position is centered when the tile image was created;
(b) an overlap that extends from the core image; and
wherein the composite image is generated by aligning the overlap of each of the one or more tile images with the overlaps of other tile images.

4. The system of claim 3, wherein each of the one or more tile images are corrected for optical distortion.

5. A device for producing high-resolution images comprising:
a camera comprising a lens with an adjustable focal length and adjustable focal point position,
wherein the device is configured to generate a composite image, created by merging a plurality of tile images obtained by adjusting the adjustable focal point position.

6. The device of claim 5, wherein the device is internet-enabled and configured to be in electronic communication with one or more cloud servers.

7. The device of claim 6, wherein generation of the composite image is done within the one or more cloud servers.

8. The device of claim 7, wherein the one or more cloud servers are configured to use an artificial intelligence model to generate the composite image.

9. The device of claim 8, wherein the adjustment of the adjustable focal point position is controlled by an artificial intelligence model configured to identify areas of high feature density and low feature density areas in a scene.

10. The device of claim 9, wherein the artificial intelligence model overlays a plurality of partitions on the scene.

11. The device of claim 10, wherein more partitions of the plurality of partitions are overlayed in areas of high feature density and fewer partitions of the plurality of partitions are overlayed in low feature density areas.

12. The device of claim 10, wherein the adjustable focal point position is adjusted to be centered on each of the plurality of partitions.

13. The system of claim 10, wherein each of the plurality of partitions are of equal size.

14. The system of claim 10, wherein a size and position of each of the plurality of partitions is determined by the presence and position of one or more areas of high feature density and low feature density areas of a scene.

15. The system of claim 14, wherein more partitions of the plurality of partitions are overlayed in areas of high feature density and fewer partitions of the plurality of partitions are overlayed in low feature density areas.

16. A computer-implemented method comprising:
capturing plurality of partially overlapping images of respective regions of a scene by using a device comprising a camera;
identifying overlaps shared between some of the plurality of partially overlapping images;
using an artificial intelligence model to generate a composite image with effective resolution greater than a single native capture of the scene.

17. The computer-implemented method of claim 16, wherein the camera comprises a lens with an adjustable focal length and adjustable focal point position.

18. The computer-implemented method of claim 17, wherein more images of the partially overlapping images are captured in areas of high feature density and fewer images of the partially overlapping images are captured in low feature density areas.

19. The device of claim 18, wherein the adjustable focal point position is adjusted to be centered on each image of the partially overlapping images.

20. The system of claim 16, wherein images of the partially overlapping images are of equal size in size.
